(19) United States
(12) Patent Application Publication
(10) Pub. No.: US 2009/0018901 A1
(43) Pub. Date: Jan. 15, 2009

(54) INFORMATION OUTPUT NETWORK SYSTEM

(75) Inventors: Akihito Toyoda, Ebina-shi (JP); Hidekazu Ozawa, Ebina-shi (JP); Hiroki Kawashima, Minato-ku (JP); Naoko Nakae, Minato-ku (JP); Hideto Itakura, Minato-ku (JP); Kouichirou Fukumoto, Minato-ku (JP); Nobuyo Yasui, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/035,084

(22) Filed: Feb. 21, 2008

(30) Foreign Application Priority Data
Jul. 11, 2007 (JP) 2007-181775

(51) Int. Cl. G06Q 30/00; G06F 17/00

(52) U.S. Cl. 705/13; 705/1; 707/104.1; 707/E17.044

(57) ABSTRACT

An information output network system includes: a route information storage unit that stores plural departure-and-arrival points in public transportation, and information on traveling routes in public transportation regarding the respective plural departure-and-arrival points; an input reception unit, provided in one of the departure-and-arrival points stored in the route information storage unit, that receives an input to specify at least one of the departure-and-arrival points stored in the route information storage unit; a search unit that searches for information on a traveling route from the departure-and-arrival point where the input reception unit is provided to the departure-and-arrival point received by the input reception unit, from the information stored in the route information storage unit; and a search result output unit that outputs the result of search by a search unit.

### CROSS-REFERENCE TO RELATED APPLICATIONS

This application is based on and claims priority under 35 USC 119 from Japanese Patent Application No. 2007-181775 filed Jul. 11, 2007.

### BACKGROUND

### Technical Field

The present invention relates to an information output network system.

### SUMMARY

According to an aspect of the invention, there is provided an information output network system including: a route information storage unit that stores plural departure-and-arrival points in public transportation, and information on traveling routes by the public transportation regarding the respective plural departure-and-arrival points; an input reception unit, provided in one of the departure-and-arrival points stored in the route information storage unit, that receives an input to specify at least one of the departure-and-arrival points stored in the route information storage unit; a search unit that searches for information on a traveling route from the departure-and-arrival point where the input reception unit is provided to the departure-and-arrival point received by the input reception unit, from the information stored in the route information storage unit; and a search result output unit that outputs a result of search by the search unit.

### BRIEF DESCRIPTION OF THE DRAWINGS

An exemplary embodiment of the present invention will be described in detail based on the following figures, wherein:

FIG. 1 illustrates the outline of an information output network system according to an exemplary embodiment of the present invention;

FIG. 2 is a front view showing the outer appearance of an image forming apparatus;

FIG. 3 is a block diagram showing a configuration of the image forming apparatus;

FIG. 4 is a flowchart showing processing (S10) performed by the image forming apparatus for railroad transfer guidance;

FIGS. 5 and 6 are examples of a transfer search screen displayed by a UI device;

FIG. 7 is an example of a starting station setting screen displayed by the UI device; and

FIG. 8 is an example of a modification of the transfer search screen displayed by the UI device.

### DETAILED DESCRIPTION

Next, an exemplary embodiment of the present invention will be described based on the drawings.

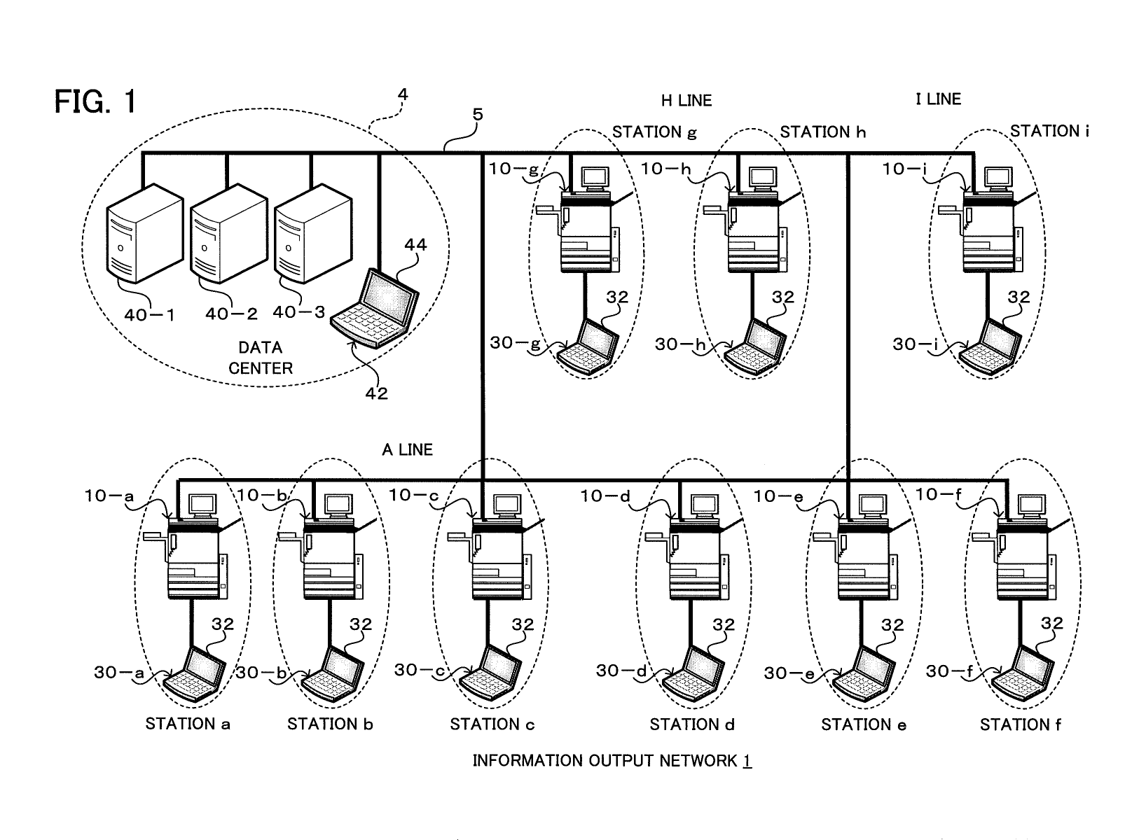

FIG. 1 illustrates the outline of an information output network system 1 according to the exemplary embodiment of the present invention. The information output network system 1 has image forming apparatuses 10-a to 10-i and terminals 30-a to 30-i respectively provided at e.g. railroad stations a to i, and servers 40-1 to 40-3 and a terminal 42 provided at a data center 4. The image forming apparatuses 10-a to 10-i, the terminals 30-a to 30-i, the servers 40-1 to 40-3 and the terminal 42 are interconnected via a network 5.

Note that the stations a to f are departure-and-arrival stations on an A line (route A), the stations g and h, departure-and-arrival stations on an H line (route H), and the station i, a departure-and-arrival station on an I line (route I).

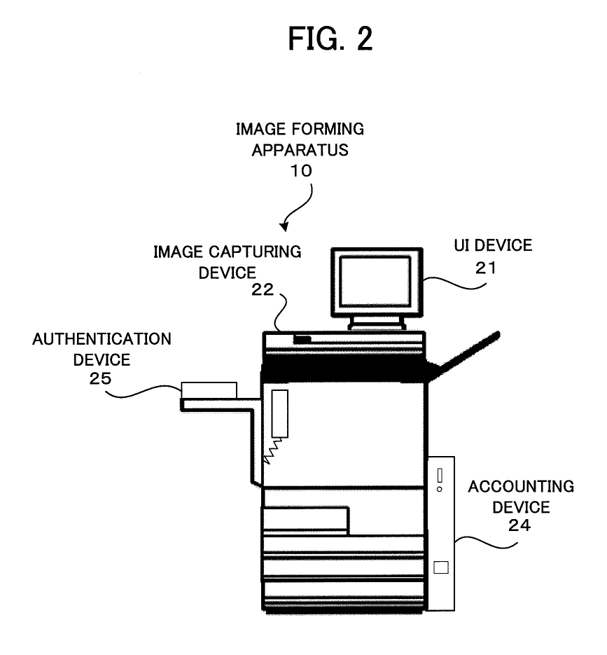

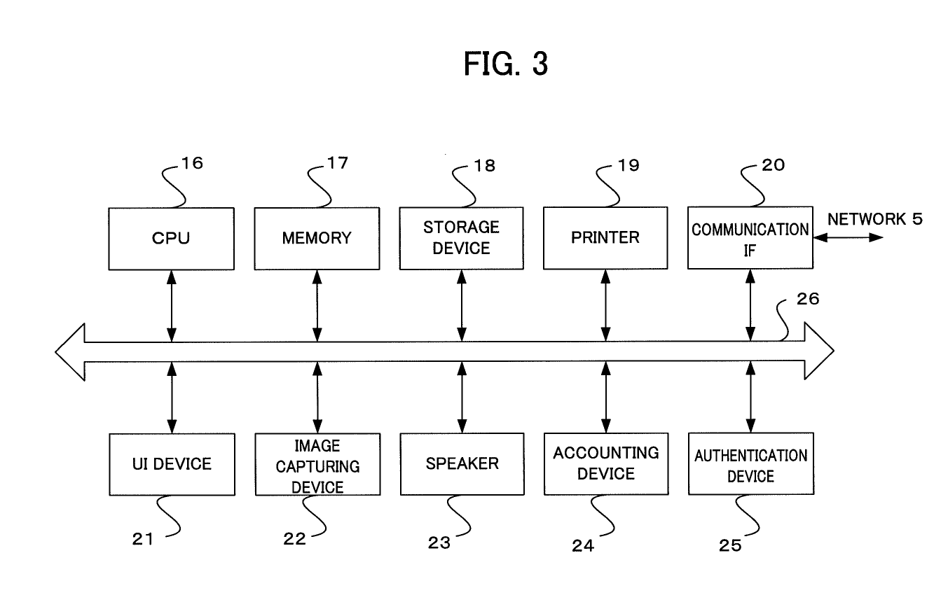

The image forming apparatuses 10-a to 10-i are multifunction apparatuses respectively having a printing function, a copying function, a facsimile transmission/reception function and a scanning function. The image forming apparatuses 10-a to 10-i are provided on e.g. platforms (or places) in the stations a to i, and output information on railroad traveling routes and the like (the details will be described using FIGS. 2 and 3). Further, the image forming apparatuses 10-a to 10-i, provided in different locations, have substantially the same configuration except settings.

The terminals 30-a to 30-i are computers respectively having a display 32 and a speaker (not shown). The terminals 30-a to 30-i are provided in e.g. station staff rooms provided in the stations a to i. Further, the terminals 30-a to 30-i, provided in different locations, have substantially the same configuration except settings.

Hereinbelow, one of the plural constituent elements such as the image forming apparatuses 10-a to 10-i may be simply referred to as e.g. an “image forming apparatus 10”.

The server 40-1 stores station names and position information of the stations a to i, information on railroad traveling routes regarding the stations a to i (necessary time between stations, fares, and numbers of transfer times etc.), and delivers the information in correspondence with access. The server 40-2 stores station local information (station map information, moving directions, ticket-vending machine operation guidance, shop information, goods information etc.) of the respective stations a to i, and delivers the information in correspondence with access. The server 40-3 stores information inputted from the image forming apparatuses 10-a to 10-i and the like, history information on processing results in the information output network system 1 and route condition information (on train delay, accident etc.), and delivers the information in correspondence with access.

The terminal 42 is a computer including a display 44 and a speaker (not shown) and the like. The terminal 42 performs setting and control and the like with respect to the servers 40-1 to 40-3.

Next, the image forming apparatus 10 will be described in detail.

FIG. 2 is a front view showing the outer appearance of the image forming apparatus 10. FIG. 3 is a block diagram showing a configuration of the image forming apparatus 10.

The image forming apparatus 10 has e.g. a CPU 16, a memory 17, a storage device 18 such as a hard disk drive (HDD), an electrophotographic printer 19, a communication interface (IF) 20 for data transmission/reception to/from the servers 40-1 to 40-3 and the terminals 30-a to 30-i and the like via the network 5, a user interface (UI) device 21 having a touch panel, an image capturing device 22 such as a scanner, a speaker 23, an accounting device 24 to charge a user (route user) a fare, and an authentication device 25 to authenticate the user. These constituent elements are interconnected via a control bus 26. In this manner, the image forming apparatus 10 has a computer function.

Note that the speaker 23 is capable of outputting an audio in accordance with control of the CPU 16. The authentication device 25 reads information stored in e.g. an authentication card such as a non-contact IC card thereby performs authentication of a user who stores the card.

Next, processing by the image forming apparatus 10 for railroad transfer guidance will be described.

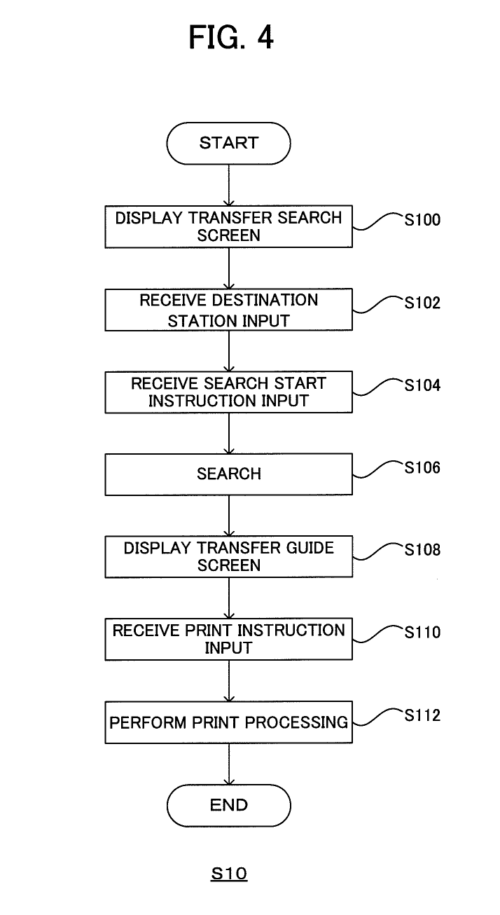

FIG. 4 is a flowchart showing processing (S10) performed by the image forming apparatus 10 for railroad transfer guidance.

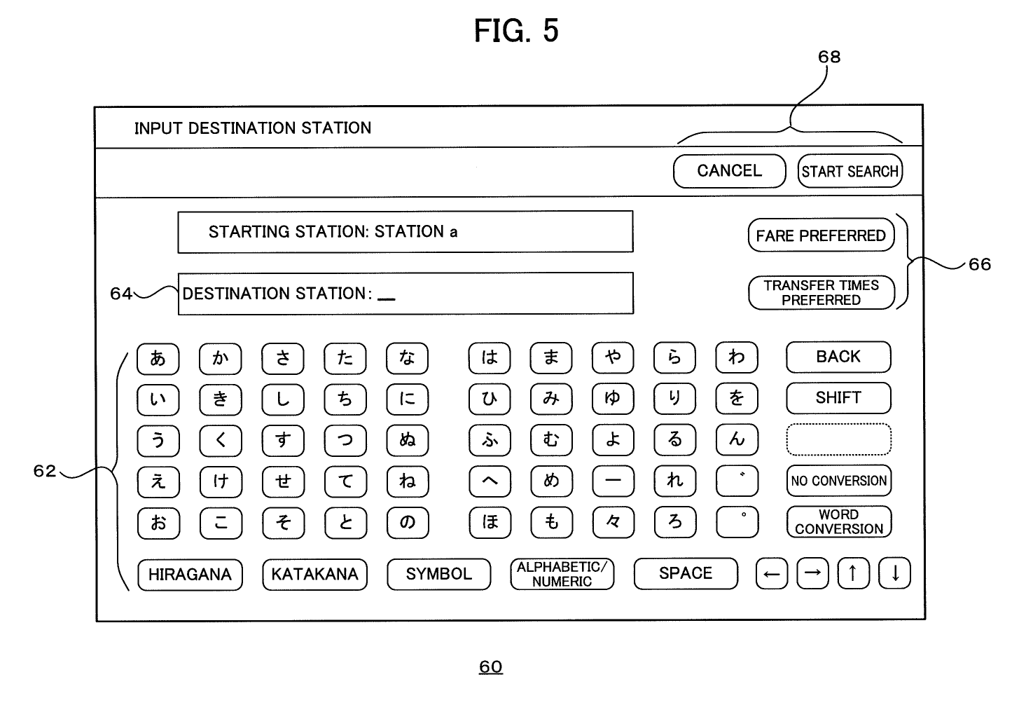

As shown in FIG. 4, at step S100, when an input has not been received for continuous time via the UI device 21, the CPU 16 displays a transfer search screen 60 as shown in FIG. 5 via the UI device 21. The transfer search screen 60 has an input reception key 62, an input display 64, a priority setting reception key 66, a search start reception key 68 and the like. In the transfer search screen 60, a station in which the image forming apparatus 10 is installed is displayed as a default starting station.

The input reception key 62 receives an input of the name of an exit station. The input display 64 displays the received name of the exit station. The priority setting reception key 66 receives setting of a priority condition upon display of plural traveling routes by the UI device 21. Note that as a default priority upon display of traveling routes, necessary time is set, and fare or the number of transfer times is set as a priority condition in correspondence with the result of reception via the priority setting reception key 66. The search start reception key 68 receives the designation of start or cancellation of search under the condition inputted with respect to the transfer search screen 60.

At step S102, the CPU 16 receives an input of the exit station via the input reception key 62 of the UI device 21, then the process proceeds to step S104.

At step S104, the CPU 16 receives an instruction input for search start via the search start reception key 68 of the UI device 21, then the process proceeds to step S106.

At step S106, the CPU 16 accesses the servers 40-1 and 40-2 and searches for information on a traveling route from the starting station to the destination station (necessary time between the stations, the fare and the number of transfer times etc.) and searches for station local information (station map information, moving directions, shop information and goods information etc.) on the found traveling route.

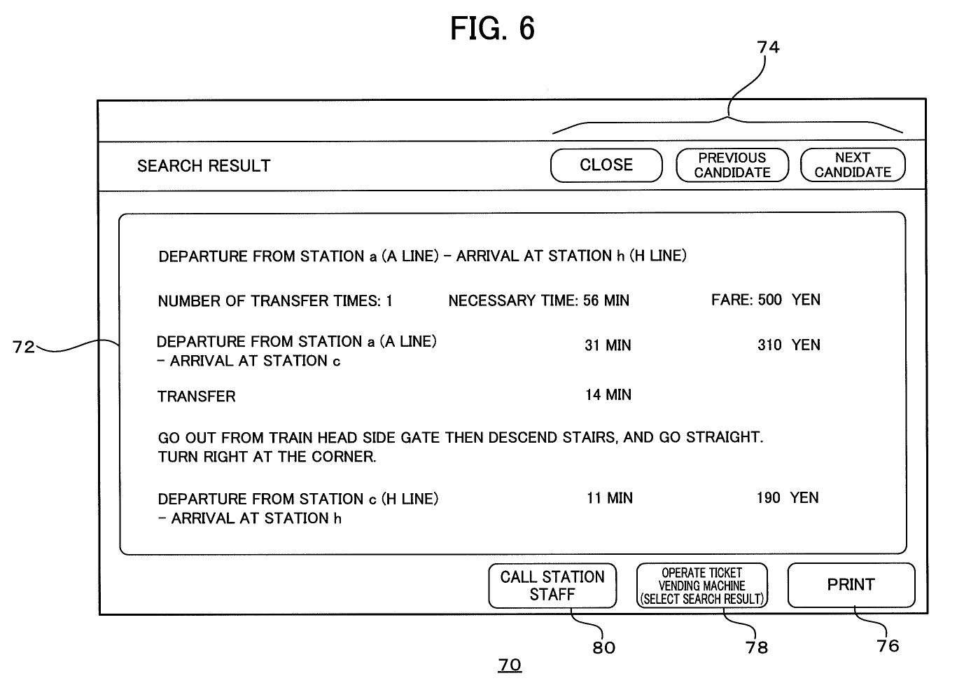

At step S108, as a search result, the CPU 16 displays a transfer guide screen 70 as shown in FIG. 6 via the UI device 21. The transfer guide screen 70 has a search result display 72, a search result display change key 74, a print instruction input key 76, a ticket-vending machine operation guide key 78 and a staff call instruction input key 80 and the like. The transfer guide screen 70 sequentially displays plural traveling routes as the search result.

The search result display 72 sequentially displays the obtained traveling route, the necessary time, the fare, the number of transfer times and moving direction guidance in transfer station and the like, by traveling route. The search result display change key 74 receives an instruction input to sequentially change the plural traveling routes. The print instruction input key 76 receives an instruction input to print a currently-displayed traveling route on the search result display 72 by the printer 19. The ticket-vending machine operation guide key 78 receives information indicating that the user selects the currently-displayed traveling route on the search result display 72 as a search result, and receives an instruction input to display guidance of operation of the ticket-vending machine corresponding to the traveling route selected by the user by the UI device 21. The staff call instruction input key 80 receives an instruction input to call station staff (station worker) to the position where the image forming apparatus 10 is installed. When the staff call instruction input key 80 is depressed, an E-mail or other information is transmitted to the terminal 42 (related information output unit), and station staff is called to the position where the image forming apparatus 10 is installed.

At step S110, the CPU 16 receives an instruction input to print the currently-displayed traveling route on the search result display 72 via the print instruction key 76 of the UI device 21, then the process proceeds to step S112.

At step S112, the printer 19 prints the currently-displayed traveling route on the search result display 72 in accordance with the control of the CPU 16.

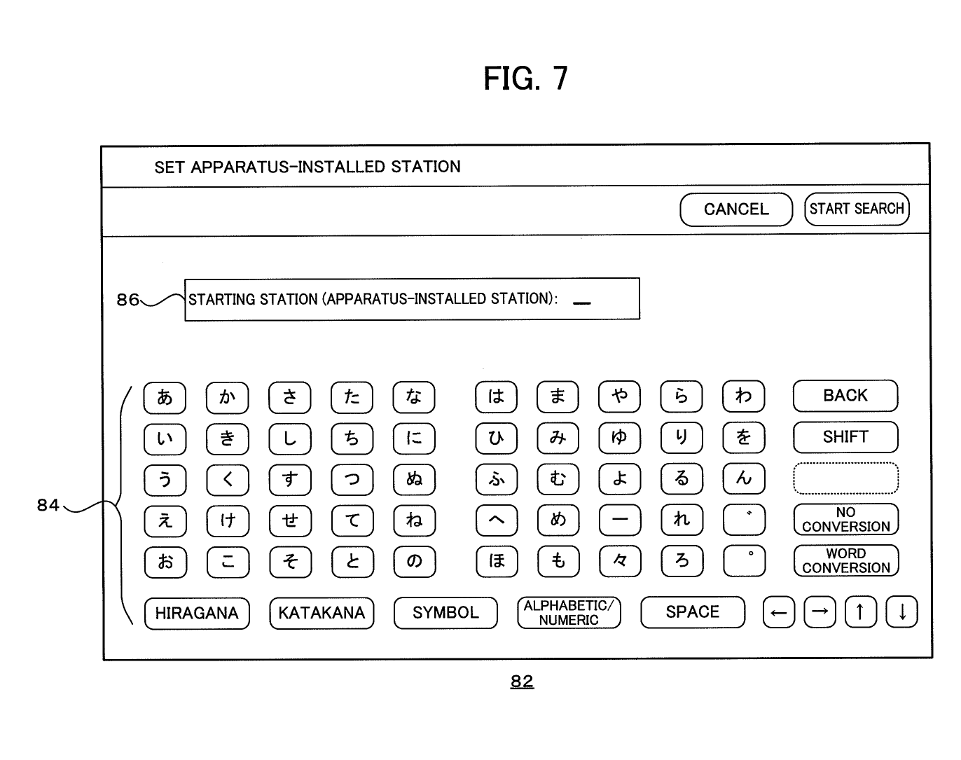

Note that in the above exemplary embodiment, the station in which the image forming apparatus 10 receiving the user's inputs is installed is a starting station. The search for traveling routes is performed without user's specifying a starting station. However, the present invention is not limited to this case. For example, it may be arranged such that a starting station setting screen 82 as shown in FIG. 7 is displayed by the UI device 21, and the user selects a traveling route from an arbitrary starting station. The starting station setting screen 82 has an input reception key 84 to receive an input of the name of starting station, a starting station display 86 to display the received name of starting station, and the like.

Further, it may be arranged such that the starting station setting screen 82 is displayed on any one of the display 44 of the terminal 42 provided at the data center 4 and the display 32 of the terminals 30-a to 30-i, and the default starting station (apparatus-installed station) in the image forming apparatus 10 is changed by station staff.

Next, a modification of the transfer search screen 60 will be described.

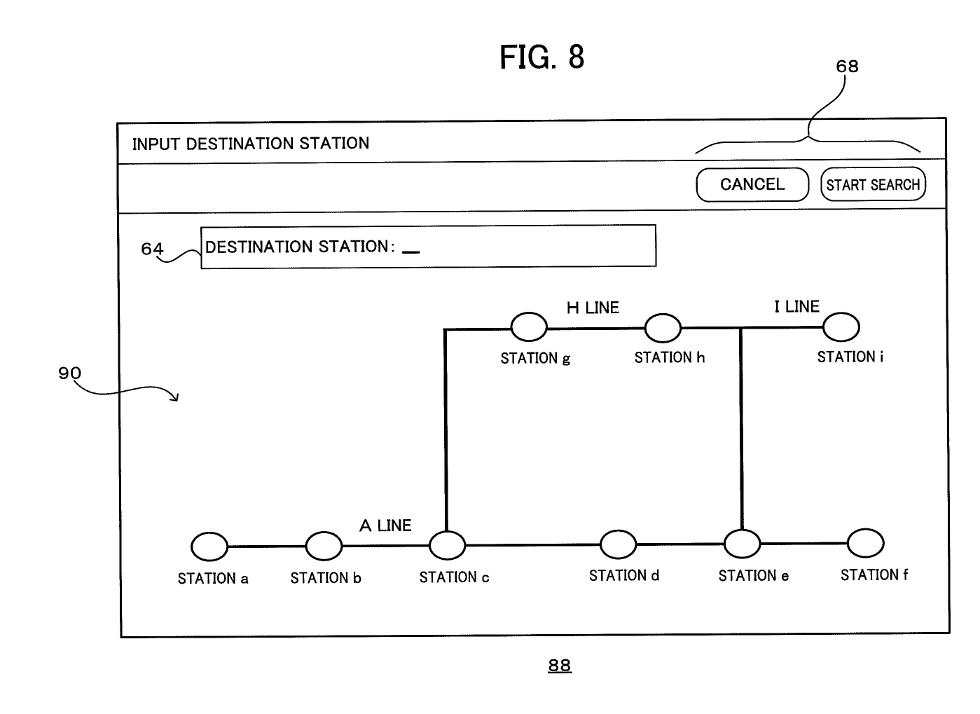

FIG. 8 is an example of the modification (transfer search screen 88) of the transfer search screen 60 displayed by the UI device 21.

Note that in the transfer search screen 88, constituent elements substantially the same as those of the transfer search screen 60 shown in FIG. 5 have the same reference numerals.

As shown in FIG. 8, it may be arranged such that the UI device 21 displays the transfer search screen 88 having a route map display 90, and when a user has selected one of the stations a to i in the route map display 90, the UI device 21 displays the name of the selected station in the input display 64 and receives an input specifying a destination station.

Further, it may be arranged such that the image forming apparatus 10 audio-outputs a search result and the like from the speaker 23 in place of display of search result obtained by accessing the servers 40-1 to 40-3 by the UI device 21. Further, the image forming apparatus 10 may print-output the search result and the like by the printer 19.

Further, it may be arranged such that in the image forming apparatus 10, when a user has selected a traveling route, the accounting device 24 performs accounting of the fare of the traveling route by cache or credit card, the printer 19 prints a ticket for the traveling route.

Further, it may be arranged such that in the information output network system 1, when the user searches for a traveling route, the authentication device 25 performs authentication of the user (acquisition of corresponding information), and information linking the user's search history with the result of user authentication is stored in the server 40-3 (corresponding information storage unit). When the user authentication (acquisition of corresponding information) is performed again on the same user at any one of the stations a to i on the traveling route, the UI device 21 may display the user's search history and route condition information (train delay, accident etc.). Note that the server 40-3 deletes the information indicating the linkage between the user's search history and the user authentication result at time of the user's arrival at the exit station on the traveling route selected from the search result, or after the elapse of one day.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information output network system comprising:
a route information storage unit that stores a plurality of departure-and-arrival points in public transportation, and information on traveling routes in the public transportation regarding the respective plurality of departure-and-arrival points;
an input reception unit, provided in one of the departure-and-arrival points stored in the route information storage unit, that receives an input to specify at least one of the departure-and-arrival points stored in the route information storage unit;
a search unit that searches for information on a traveling route from the departure-and-arrival point where the input reception unit is provided to the departure-and-arrival point received by the input reception unit, from the information stored in the route information storage unit; and
a search result output unit that outputs a result of search by the search unit.

2. The information output network system according to claim 1, wherein the search result output unit performs at least one of display, printing and voice production, thereby outputs the result of search by the search unit.

3. The information output network system according to claim 1, further comprising:
a first corresponding information acquisition unit that obtains information corresponding to the input received by the input reception unit;
a corresponding information storage unit that stores the information obtained by the first corresponding information acquisition unit;
a second corresponding information acquisition unit, provided in a departure-and-arrival point on the traveling route found by the search unit, that obtains the same information as the information obtained by the first corresponding information acquisition unit;
an information output unit, provided in a departure-and-arrival point on the traveling route found by the search unit, that outputs information; and
an information output controller that, when the second corresponding information acquisition unit has obtained the information, controls the information output unit to output the information on the result of search outputted by the search result output unit.

4. The information output network system according to claim 2, further comprising:
a first corresponding information acquisition unit that obtains information corresponding to the input received by the input reception unit;
a corresponding information storage unit that stores the information obtained by the first corresponding information acquisition unit;
a second corresponding information acquisition unit, provided in a departure-and-arrival point on the traveling route found by the search unit, that obtains the same information as the information obtained by the first corresponding information acquisition unit;
an information output unit, provided in a departure-and-arrival point on the traveling route found by the search unit, that outputs information; and
an information output controller that, when the second corresponding information acquisition unit has obtained the information, controls the information output unit to output the information on the result of search outputted by the search result output unit.

5. The information output network system according to claim 1, wherein the input reception unit displays traveling routes by the public transportation regarding the plurality of departure-and-arrival points, thereby selects of a departure-and-arrival point, and receives an input to specify at least one of the departure-and-arrival points.

6. The information output network system according to claim 2, wherein the input reception unit displays traveling routes by the public transportation regarding the plurality of departure-and-arrival points, thereby selects of a departure-and-arrival point, and receives an input to specify at least one of the departure-and-arrival points.

7. The information output network system according to claim 3, wherein the input reception unit displays traveling routes by the public transportation regarding the plurality of departure-and-arrival points, thereby selects of a departure-and-arrival point, and receives an input to specify at least one of the departure-and-arrival points.

8. The information output network system according to claim 1, further comprising a change reception unit that receives an input to change the departure-and-arrival point where the input reception unit is provided to another departure-and-arrival point.

9. The information output network system according to claim 2, further comprising a change reception unit that receives an input to change the departure-and-arrival point where the input reception unit is provided to another departure-and-arrival point.

10. The information output network system according to claim 3, further comprising a change reception unit that receives an input to change the departure-and-arrival point where the input reception unit is provided to another departure-and-arrival point.

11. The information output network system according to claim 4, further comprising a change reception unit that receives an input to change the departure-and-arrival point where the input reception unit is provided to another departure-and-arrival point.

12. The information output network system according to claim 1, wherein the route information storage unit further stores information on the respective plurality of departure-and-arrival points, and the search unit further searches for information on the found departure-and-arrival point on the traveling route.

13. The information output network system according to claim 2, wherein the route information storage unit further stores information on the respective plurality of departure-and-arrival points, and the search unit further searches for information on the found departure-and-arrival point on the traveling route.

14. The information output network system according to claim 1, wherein the search unit searches for information on a plurality of traveling routes.

15. The information output network system according to claim 14, wherein the route information storage unit stores information on at least one of necessary time, a fare and the number of transfer times respectively regarding the plurality of traveling routes, as a part of the information on the traveling routes, and
the information output network system further comprising a priority order controller that controls the search result output unit to output the result of search by the search unit in accordance with a priority order based on one of the necessary time, the fare and the number of transfer times stored in the route information storage unit.

16. The information output network system according to claim 15, further comprising a priority setting reception unit that receives setting of the priority order controlled by the priority order controller.

17. The information output network system according to claim 14, further comprising:
a selection reception unit that receives an input to select one of information on the plurality of traveling routes outputted by the search result output unit; and
a payment information output unit that outputs information on payment of the fare for the traveling route in correspondence with the input received by the selection reception unit.

18. The information output network system according to claim 17, wherein the payment information output unit performs at least one of display, printing and voice production, thereby outputs the information on payment of the fare for the traveling route.

19. The information output network system according to claim 14, further comprising:
a selection reception unit that receives an input to select one of the information on the plurality of traveling routes outputted by the search result output unit;
an accounting unit that performs accounting of a fare for the traveling route in correspondence with the input received by the selection reception unit; and
a print unit that, upon accounting of the fare by the accounting unit, prints a ticket corresponding to the input received by the selection reception unit.

20. The information output network system according to claim 1, further comprising:
an information transmission/reception unit that receives an input indicating necessity for transmission of information to a place different from a place where the input reception unit is provided; and
a related information output unit, provided in the place different from the place where the input reception unit is provided, that, when the information/transmission reception unit receives the input, outputs information related to the output from the search result output unit.
